(19) United States
(12) Patent Application Publication
(10) Pub. No.: US 2008/0223134 A1
(43) Pub. Date: Sep. 18, 2008

(54) Method and Device For Testing the Stability and/or Bending Strength of Masts

(76) Inventors: Sven Homburg, Wendelstein (DE); Gunther Jost, Weidenbach (DE)

Correspondence Address: COOK ALEX LTD, SUITE 2850, 200 WEST ADAMS STREET, CHICAGO, IL, 60606, US

(21) Appl. No.: 11/997,773

(22) PCT Filed: Jul. 24, 2006
(86) PCT No.: PCT/EP06/07285

§ 371 Date: Feb. 4, 2008

(30) Foreign Application Priority Data
Aug. 9, 2005 (DE) 10 2005 038 033.6

(51) Int. Cl. G01M 7/00; G01M 5/00

(52) U.S. Cl. 73/579; 73/786

(57) ABSTRACT

The invention relates to a method and a device (10) for testing the stability and/or bending strength of masts (11), especially non-guyed masts (11). According to said method,
a) the test is performed dynamically,
b) the mast being excited by means of an artificially generated florce so as to perform movements particularly vibrations, and
c) the movements of the mast (11) are determined with the aid of one or several sensors (acceleration sensors, (13, 14)) which are disposed on the mast (11) and detect acceleration values in the respective position thereof on the mast (11). The device (10) comprises a)
a) an imbalance exciter (12) that may be is attached to the mast (11), for generating a force to be applied to the mast (11) that is to be tested,
b) one or more acceleration sensors (13, 14) that may be attached to the mast (11), and
c) an analysis arrangement (21) for determining stability and/or bending strength of the mast (11).

The invention concerns a process and a mechanism for testing the stability and/or bending strength of masts, in particular masts that are non-guyed.

In general, a mast is understood to be a longish object, in particular a type of rod that is anchored or secured in a mast base at one longitudinal end, while the opposite longitudinal end, the mast top, usually extends freely. The anchoring or securing of the mast at the mast base usually takes place in the ground, for example in a foundation. Usually, the mast then stands vertically. But anchoring in a wall is also possible.

The masts that are to be tested can be used for various purposes, for example, as masts for electricity or telephone lines, train masts, antenna masts, flag poles, masts for wind energy systems, lamp posts and mast for traffic lights and/or traffic signs. Masts made of all conceivable materials can be tested, for example, masts made out of wood, plastic, concrete and/or metal.

Usually, masts are provided with a circular or oval cross section, but other forms of cross sections, for example, with corners (e.g. quadratic or rectangular) are also possible. The diameter of a mast can be constant for the entire height, but it can also change along the mast, in particular, the diameter can decrease starting with the mast base up to the mast top.

Masts made of solid material, as well as masts with a hollow interior are known. Masts are bordered laterally toward the exterior by lateral surfaces, whereby the lateral surfaces can be described as casing surfaces in the case of round and oval masts.

Mostly, the anchoring of the mast base must secure the stability of the mast by itself. As additional safety, guyeing of the mast, in particular at the mast top is known. However, this safety measure is eliminated in many cases, for example, because of space relationships (e.g. in communities or in street traffic) or because of absent or expensive fastening possibilities for guyeing ropes or rods.

Masts are exposed to constant atmospheric conditions, particularly wind. So that they are able to withstand the forces acting upon them and do not topple or bend, the masts must, in particular those that are non-guyed, show sufficient stability and bending strength. But precisely these characteristics can worsen over the course of time because of the many atmospheric influences to which masts are exposed, for example, moisture, fluctuations in temperatures, exposure to sun and industrial or traffic emissions, in particular due to material fatigue in the mast or anchoring (foundation).

Reduced stability and/or bending strength increases the risk of an accident caused by a toppling or bending mast. This can be prevented by regular testing of the stability and/or bending strength. Beyond that, a corresponding test directly after manufacture or during new erection of a mast can make sense (zero measurement), to determine manufacturing material and/or anchoring defects right at the beginning.

From DE 94 04 664 U1 and EP 0 638 794 B1 a procedure and an arrangement for testing the stability and bending strength of masts is known. In the process, a mast which is to be tested is exposed to a variable bending moment by exposing it to a force that is introduced above its anchoring and increased in the course of the testing process. The force and the distance by which the mast is deflected laterally from a selected point as a result of the bending moment is measured with sensors. Based on the development of the relationship of these two values with respect to one another up to a reference test load, a conclusion is drawn whether the mast shows sufficient stability or not.

A further development of this with which in addition, information about the absence of cracks or the presence of cracks of the mast is to be gained as well is known from DE 296 07 045 U1. Here, drag and compression forces are introduced above the anchoring of the mast to expose the mast to bending moments that are directed in opposite directions. By comparing the determined force-vector-diagram in the compression and drag exposure case or by comparing reference values, a conclusion about the crack formation in the mast is then drawn.

A comparable mechanism is known from DE 100 62 795 A1.

These procedures and mechanisms work in principle with a quasi static force for which the deflection of the mast is measured as a reaction. This static condition is measured successively for various forces, so that a force-vector-diagram results that is consulted for corresponding analysis. The dynamic reaction of the mast to natural forces that occur in practice is, however, not captured and is thus not available for analysis.

The dynamic load of the mast that occurs in practice, i.e. the vectorial addition of an external force, for example, wind or earth quake, plus the internal forces that result from the self-reinforcing tendencies of the oscillating mast is, however, not captured and is thus not available for an analysis.

An additional disadvantage of these processes and mechanisms for ensuring sufficient stability is, that the mast must be exposed to forces that correspond to the maximum loads that are to be expected, which must even go significantly beyond such. For example, a static maximum load of 1.5 times of the wind load is reasonable. These artificial, static loads can lead to an overload for the mast and thus to damage of the mast or its anchoring (foundation).

In DE 102 29 448 A1, an arrangement for controlling the stability of a mast anchored in the ground is revealed, in which an oscillating sensor is permanently affixed to the mast. The oscillation excitement results exclusively from the natural load of wind and weather on the mast. If the oscillations of the mast deviate with respect to frequency, amplitude or type of oscillation from a prescribed standard, this is assessed as evidence of a mast defect. The test is understood only as a preliminary test that is to provide grounds for a comprehensive inspection in the event a corresponding result is obtained.

The advantage of the latter arrangement is in the reduction of the quantity of masts that are to be tested. However, the results are to be assessed merely as evidence, as this arrangement can not provide reliable information about stability and bending strength.

It is the problem of the invention to indicate a process and a mechanism for testing the stability and/or bending strength of masts that overcomes the previously mentioned disadvantages of prior art.

With respect to the procedure, this problem is solved by the characteristics of Patent claim 1, with respect to the mechanism by the characteristics of claim 30.

Advantageous designs and further developments result from the dependent claims respectively.

The process for testing stability and/or bending strength of masts, in particular non-guyed masts according to claim 1 provides,
a) that the test is dynamic,
b) whereby the mast is excited and put into motion by artificially generated forces, in particular oscillations, and
c) whereby the motions of the mast are determined by one or more sensors that are located on the mast, in particular acceleration sensors that capture the measurements at their respective position on the mast.

The advantages attained with the invention consist in particular therein, that not only static values are available for analysis, but in addition most notably, the dynamic behavior of the mast is also captured and can thus be analyzed. Thereby, the real load of natural forces, in particular wind forces, can be simulated significantly better. The known analysis using a force-vector-diagram can, however, be performed in this process as well, as the vector can be determined by twofold integration of the measurements or acceleration measurements.

Further, in the dynamic process according to the invention, sufficient results with significantly smaller forces can be gained than with the static process, so that the hazard that is given in prior art due to the required large forces of an overload on the mast and thereby the possibility of damage to the mast are not present during testing.

Capturing the dynamic behavior of the mast upon excitement by a force, i.e. the displacement behavior of the mast is to be understood by a dynamic test. Accordingly, work is not done with position encoders as in prior art, but preferably with acceleration sensors.

Commercially available devices can be used as acceleration sensors (or: acceleration gauge). These operate, for example, according to the spring-mass principle with micro-mechanical methods and capacitive analysis, with magnetic field sensors, with pressure sensors or with Piezo electricity.

By artificially generated force, as opposed to a natural wind force, a targeted force effect is to be understood, usually generated by a mechanism that is suitable for it, which acts upon the mast. Thus, the test is not dependent on random naturally occurring forces, but can be reproduced by corresponding control of the artificially generated force using a prescribed or prescribeable test plan. Also, not all measurements must thereby be performed parallel; rather on the basis of the reproducibility of the forces, a measurement of parameters is possible in consecutive order, whereby the measurements can subsequently be correlated with one another.

Advantageously, the mast motions are excited by a force that changes in time, space or in direction and/or in intensity.

It is also shown to be advantageous when the mast motions are excited by a force that changes periodically in direction and/or intensity. It is expedient thereby, that the excitement frequency of the force can be selected, in particular continuously. In particular, the selectability should also include the generation of fundamental wave (or resonance frequencies) and if appropriate, also harmonic waves of the mast to be tested, and thereby make resonance excitements possible. This can also take place automatically adaptive.

In accordance with a further development, the force exciting the mast motions can also be a force impulse and/or the consequence of a force impulse. By force impulse, a short-term force effect is to be understood that immediately falls back to zero or to a smaller value. Thereby, wind bursts can be simulated.

Advantageously, the force is primarily on one level perpendicular to a longitudinal axis (or: longitudinal middle axis, longitudinal mast axis, mast axis) of the mast, in particular, it is directed radially to a longitudinal axis of the mast. The artificial force thus attacks laterally at the mast, just like a natural wind force.

According to a preferred embodiment of the process, the force runs circular around a longitudinal axis of the mast, in particular periodically and/or with constant intensity of force over time. A force of such type creates a circular mast motion around the longitudinal axis in the static condition.

Alternatively, the direction of the force can be on a straight line perpendicular to a longitudinal mast axis and the force vector can change over time. The mast deflection then takes place at a level parallel to the longitudinal mast axis in static condition, which is occupied by the longitudinal mast axis in static condition as well.

Advantageously, it could also be that the force is applied torsional to the mast, in particular, at least with respect to one force component tangential at one lateral surface or casing surface of the mast. Thereby, the mast is distorted around its longitudinal axis. It is also possible that a force is provided with a radial as well as a tangential force and thereby with components that act torsional.

Preferably, the force acting upon the mast is generated by a mechanism that is located on the mast, in particular at the upper third of the mast height and/or at an exterior side, preferably an exterior lateral surface or casing surface of the mast. An attachment of the mechanism in the upper third ensures that the artificially generated force is applied in that section and thus based on the distance to the anchored mast base—compared to an attachment in the lower mast section—a reaction of the mast to the exciting force that is as large as possible. Attachment on the exterior side or in the case of round or oval masts at the casing surface is expedient, as thereby no expensive installment of the mechanism in the interior of the mast is necessary, which would only be possible in correspondingly designed masts anyway.

It was shown to be particularly advantageous to use an imbalance exciter as the mechanism for generating a force. Thereby, it is expedient to use an imbalance exciter whose imbalance generates the desired forces upon corresponding motion that is based essentially on at least one mass. Preferred are even two or more masses. These masses are displaced during operation of the imbalance exciter, i.e. for generating the forces.

It is particularly advantageous when the mass or masses of the imbalance exciter is/are displaced around the longitudinal axis of the mast and/or around the mast. In particular, the masses should be displaced radially outside of the exterior side or—in the case of round or oval masts—of a casing surface of the mast. The masses should thus revolve around the mast, i.e. preferably be in motion circling around the mast, and do so at a level perpendicular to the longitudinal axis of the mast.

Preferred is also, that the mass or masses is/are driven by one or more linear drives, in particular one or more linear motors. A linear motor is comprised of individual elements (linear or exciter winding), that can also generate a circular motion of the masses around the mast when located correspondingly. For example, such a linear motor can be provided with 256 elements that are attached to a ring. The mass or masses form, inter alia, the runner of the linear motor.

The maintenance of distance between the linear winding and runner preferably takes place by electromagnetic suspension, i.e. the mass or masses are suspended and controlled electromagnetically. Thus, in operation they do not have any direct contact with other components; the frictional loss is therefore small.

In an alternative embodiment, the runners can also be guided mechanically.

For example, the required or desired forces can be generated by an imbalance exciter in which two masses revolve in a circle or elliptically. In a corresponding arrangement of this imbalance exciter on the mast, both masses thus run circular or elliptically around the mast or the longitudinal axis of the mast. Such an imbalance exciter can be realized by two drives, whereby in each drive one mass revolves. Advantageously, both linear drives are located above one another, so that the radii of the orbits of the masses correspond to one another. In this case the two masses should correspond to one another, i.e. inter alia, they should have the same weight and form. The effect of an elliptically revolving mass can also be attained with a two-part mass consisting of a base mass and a trim mass that uses a circular track if the distance between the base mass and the trim mass—aligned with the frequency of revolution on the circular track—is periodically changed.

If both masses, each of which can potentially be designed in two parts including the base mass and trim mass are controlled in such a way that they are displacing counter to one another around the mast and do so at the same speed on radial tracks revolving around the axis of the mast, i.e. that the force is always at one level parallel to the longitudinal axis of the mast. This results because each mass generates a radially revolving force by itself. The forces emanating from the vectorial addition of the two counter rotating masses results in a variable linear force, i.e. a force that changes periodically with the revolving frequency of the mass at one level parallel to the axis of the mast. Correspondingly, the mast is excited to perform a linear deflection motion, i.e. a mast deflection takes place at a level parallel to the longitudinal axis of the mast in the static condition, which is occupied by the longitudinal axis of the mast in the static condition as well. The radial “meeting points” of the revolving masses are also on this level. As the masses revolve axially along the axis of the mast, offset with respect to one another, these “meeting points” are the intersection points of the tracks of the masses that result from axial projection respectively.

These intersection points can be determined by the variation of the activation of the phases of the drives, so that the desired oscillation level can be selected electrically/electronically. A time-intensive mechanical rotation of the mechanism is dispensed with.

A circular mast deflection motion (in contrast to a linear deflection motion, here the mast circles around the mast axis in static condition) can be created with such a mechanism with two masses, for example, by a synchronous, i.e. a revolving displacement in the same direction of both masses, in particular, by masses that revolve parallel to one another.

A force with torsional effect on the mast can be generated by braking and/or accelerating the masses, whereby this can also be attained with an imbalance exciter with one mass, with two masses or with more masses by corresponding mass control.

According to an expedient variation of an embodiment of the process, the captured measurements or acceleration measurements are horizontal acceleration measurements that are determined primarily at one level perpendicular to a longitudinal mast axis, in particular by motion sensors for detecting lateral motions that are attached to the mast, i.e. horizontal motion sensors. In addition or alternatively, vertical acceleration measurements can also be captured that are primarily determined parallel to one longitudinal mast axis, in particular by motion sensors attached to the mast for capturing longitudinal motions, i.e. vertical motion sensors.

According to a further development, horizontal acceleration measurements are determined at one or several measuring levels distributed over the mast height, in particular at three measuring levels, whereby preferably the first measuring level is in the lower third of the mast height, and the second measuring level is in the middle third of the mast height and a third measuring level is located in the uppermost third of the mast height.

Thereby, the acceleration measurements can be determined parallel at various measurement levels by the arrangement of a corresponding number of acceleration sensors. Alternatively, it is likewise possible that the measurements or acceleration measurements of various measurement levels are determined consecutively by, for example, a robot with acceleration sensors that can be driven consecutively to the respective measuring levels on the mast along the mast (in particular self-propelled). Preferably, the robot controls the respective measuring levels self-directed or automatically by a control arrangement. However, a prerequisite requires that there are no barriers on the mast, for example, attached signs or cables running at the exterior of the mast. If necessary, barriers must be removed. Alternatively, the process is also possible by hanging a rope.

In an additional variation of the process measurements or acceleration measurements are determined on at least one measurement level, particularly two or more, preferably four, at the uppermost measurement level, whereby the measurement points are evenly distributed over the measurement level on the mast. This means that for four measurements at one level these are located perpendicular to one another with respect to the longitudinal axis of the mast. The measurements or acceleration measurements of a measurement level can be determined parallel by a corresponding number of acceleration sensors that are located perpendicular to one another with respect to the longitudinal axis of the mast. But the measurements or acceleration measurements of a measuring level can also be determined consecutively if, for example a robot is attached to the mast which can rotate one or more of the acceleration sensors around the longitudinal axis of the mast for recording the various measuring positions within a measuring level. This robot and the previously mentioned robot that can be driven along the mast can be one mechanism.

A further development of the process provides that one or more vertical measurements or acceleration measurements, in particular two vertical acceleration measurements are determined at or in the proximity of the mast base. The mast base is (usually in a foundation) the anchored longitudinal end of the mast. To determine two vertical acceleration measurements, the acceleration sensors are preferably located at respectively two opposite sides of the mast or in the proximity of the mast base.

The process according to the invention makes acceleration measurements and thus dynamic measurements available for analysis. By comparing these measurements or the values calculated from them, for example, for various measurement levels and/or directions of deflection, and/or by comparison of reference values, for example, a theoretically calculated value or values from earlier measurements, conclusions can be drawn about the stability or bending strength of the mast. In particular, the following statistical values of the masts can be tested: toppling of foundation, deformation of the mast over its height and torsion load.

For analysis, the process provides in a further development that
a) by twofold integration of the determined horizontal acceleration measurements, the mast deflection can be calculated at the respective measurement levels and that from this a measured (i.e. actual) deflection line of the mast is determined,
b) the measured deflection line is compared with a control deflection line, particularly considering the exciting force and/or the cross section of the mast and/or the mast material of the theoretically determined deflection line, and
c) deviations are determined between the measured and the control deflection line.

In addition or as an alternative, the system characteristics of the mast in new condition (zero measurement), can be assumed when determining the control bending line.

In a further step, as a result of deviations that can then be determined between the measured and calculated bending line, quality defects of the mast, in particular material defects and/or inclusions and/or breaks can be recognized. Thus, the bending strength of the mast can be determined and evaluated. Particularly decisive are recognizable non-linearities in the bending behavior.

For analysis, the mast deflection at the respective measurement levels can also be calculated by twofold integration of the determined horizontal acceleration measurements and from this a force-deflection diagram can be created, the course of which is made up especially of recognizable non-linearities, quality defects of the mast, in particular material defects and/or inclusions and/or breaks.

Thus, in the dynamic process according to the invention, an analysis is also possible as described in prior art at the beginning (static process).

In a further development of the process it is provided that
a) by twofold integration of several horizontal acceleration measurements that have been determined at one measuring level, mast deflections in various directions are determined, and
b) from differences between these deflections, particularly with respect to the degree of the maximum deflection, quality defects of the mast, particularly cross section deformations and/or distortions of the mast are recognized.

According to an advantageous additional analysis step
a) by twofold integration of the determined vertical acceleration measurements, in particular of acceleration measurements determined on two opposite mast sides, the motion of the respective measurement points is to be determined and it
b) from these motions and the distance of the measurement points from one another, a toppling of the mast in its anchoring (foundation) is to be determined.

Thereby, the stability of the mast can be determined and evaluated.

A convenient and advantageous further development provides that from the motion of the mast that was excited by the force at various excitement frequencies, the frequency response, the dampening coefficient, in particular the maximum deflection of the mast at different excitement frequencies, the resonance frequency of the mast is determined. The maximum deflection for a certain excitement frequency can be determined respectively by a twofold integration of the acceleration measurements that were determined.

According to claim 30, the mechanism for testing the stability and/or bending strength of masts, in particular non-guyed masts, preferably via a previously described dynamic process includes,
a) an imbalance exciter that is attached to the mast or can be attached to such, in particular in the upper third of the mast height for generating a force that acts upon the mast to be tested, in particular a periodic force,
b) one or more acceleration sensors that are attached to the mast or can be attached to such, for capturing and c) an analysis arrangement for determining the stability and/or bending strength of the mast to be tested and/or quality defects of the mast to be tested.

The advantages of this mechanism are evident from the preceding explanations about the process.

Preferably, the imbalance of the imbalance exciter is based primarily on at least one mass, preferably on two or more masses. This mass or masses is/are put in motion when the imbalance exciter is operated.

According to a further development, the mass is or the masses are put in motion in a circle around the longitudinal mast length, in particular outside of the mast, preferably radially outside one lateral surface or casing surface of the mast.

Advantageously, the mass is or the masses are driven by a linear drive, in particular a linear motor that is, for example, comprised of 256 elements (field windings), particularly ring-shaped. It is also advantageous when the mass or the masses are suspended electromagnetically controlled, i.e. during operation they do not show any contact with other components.

Especially for the process variations discussed above which provide for a process of acceleration sensors in various measuring positions, the mechanism should include at least one robot for positioning the acceleration sensors and/or imbalance exciters on the mast to be tested, whereby the robot places or can place two or more components that are connected with one another ring-shaped around the mast to be tested, and at least one arrangement for affixing acceleration sensors and/or imbalance exciters. Thereby, at least one connection component can be a hinge.

Expedient is further, if the robot includes a mechanism for driving the robot along the mast, preferably a mechanism with driven wheels that abut the mast during operation. Thereby, the attachment of the wheels should be designed flexibly, so that the robot can be used for masts with various diameters. A flexible suspension of wheels also makes it possible to drive the robot along a mast axis with changing mast diameter. This is attainable by spring-mounting the wheels or by a corresponding controllable mounting suspension of the wheels, in which the control always ensures a firm abutment of the wheels on the mast.

A further development of the mechanism is expedient as well in which the robot includes a mechanism for rotating the arrangement for affixing acceleration sensors around the longitudinal axis of the mast. Thus the acceleration sensors can be brought automatically into various measuring positions within a measuring level.

In the following, the invention is described in further detail by referring to the enclosed drawings. Shown are:

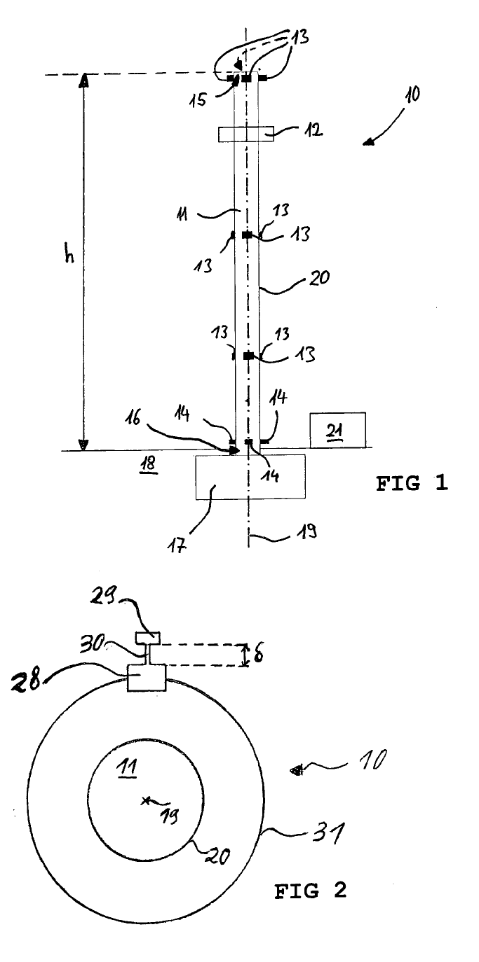

FIG. 1 an embodiment of a mechanism according to the invention, located on a mast that is to be tested,

FIG. 2 a diagram of a cross section of a longitudinal axis of the mast of an additional example of an embodiment of a mechanism in accordance with the invention, located on a mast that is to be tested,

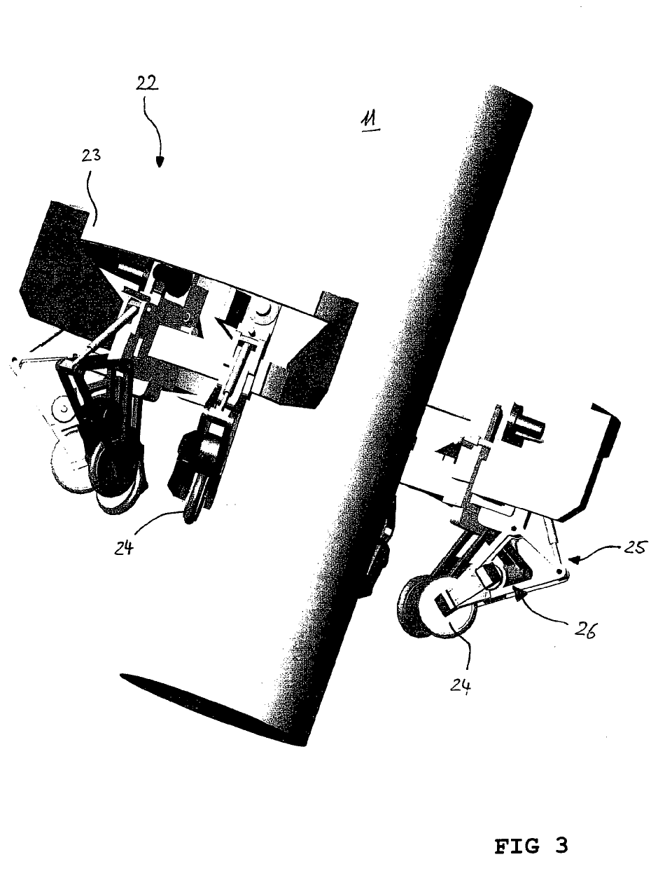

FIG. 3 an example of an embodiment of a robot of a mechanism in accordance with the invention in the condition in which it is not affixed to the mast, and

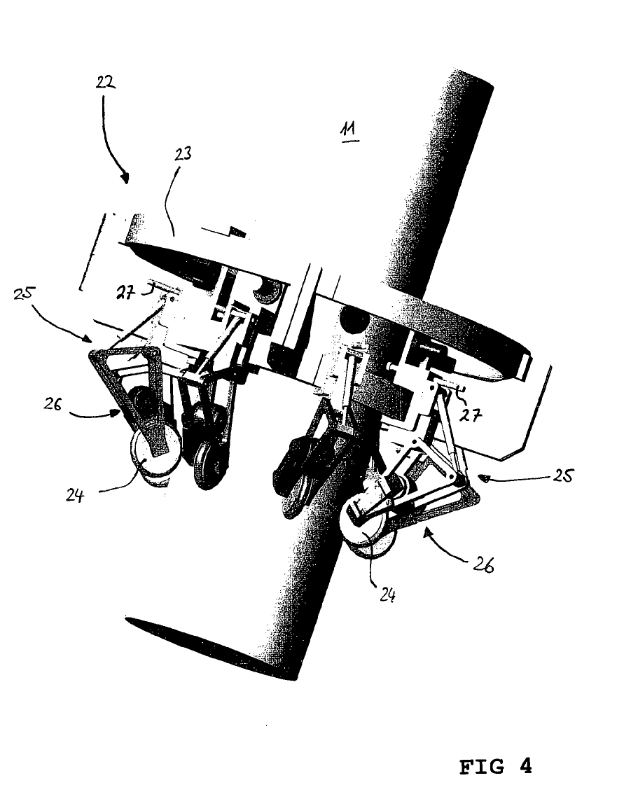

FIG. 4 a robot according to FIG. 3 affixed on a mast.

Components that correspond to one another and are labeled with the same reference numbers in FIG. 1 to FIG. 4.

FIG. 1 shows an example of an embodiment of a mechanism 10 for testing the stability and or bending strength of masts according to the invention affixed to a mast to be tested 11. This mechanism 10 is equipped for and designated to perform the testing process for stability and/or bending strength of a mast 11 according to the invention.

Mast 11 is a longish object with a mast (longitudinal) axis 19. In FIG. 1, the diameter of mast 11 is constant over its entire length; however, a mast with changing diameter along the length of the mast is also possible. Mast 11 is provided with a mast top 15 at one longitudinal end, and at the longitudinal end opposite to mast top 15 a mast base 16. Mast 11 is anchored in a foundation 17 with mast base 16 in ground 18 and projects perpendicularly upward from ground 18. It is not guyed, i.e. the anchoring of mast base 16 is in foundation 17 and in ground 18 and must guarantee sufficient stability for mast 11. The height of mast top 15 above ground 18 is described as mast height h. The mast can, for example, be made of wood, metal, concrete and/or plastic. It can be hollow in the interior, for example for leading lines through it, but likewise, it can be designed without a cavity The diameter of the mast can be round or oval, but other cross sectional shapes are also possible, for example, square or rectangular cross sections or T-shaped or U-shaped cross sections. Towards the outside, mast 11 is bordered laterally by a lateral surface or casing surface 20.

The process according to the invention is to test the stability of mast 11, i.e. in particular the strength of the anchoring in ground 18, as well as the bending strength of mast 11, i.e. its elasticity or stability against damage by exposure to loads.

For this, the location of various components of mechanism 10 is shown in FIG. 1 in stylized form. Mechanism 10 includes, as shown diagrammatically in FIG. 1, an imbalance exciter 12, that is designated to generate a force acting upon mast 11 that is to be tested, in particular, a periodic force. Imbalance exciter 12 is located in the upper third of mast height h at mast 11.

The imbalance of imbalance exciter 12 in a first variation is based on a mass (not shown). During operation of imbalance exciter 12, this mass revolves within imbalance exciter 12 around mast 11, i.e. the mass revolves circular (or elliptically) around mast axis 19, and it does such radially outside of lateral surfaces or casing surfaces 20 of mast 11. This leads to a circular (or elliptical) motion of mast 11 around mast axis 19 in the static condition of mast 11, i.e. the circulating mass first exerts a radial force upon mast 11 that leads to a mast deflection, and further, the deflection force revolves around the mast axis because of the revolving mass, so that overall the circulating deflection motion of mast 11 results. Mast 11 is thus excited by the artificially generated force that emanates from the imbalance of the imbalance exciter 12 in connection with its internal forces to generate motion, in particular, oscillations the capturing of which represents the core of the testing process.

The motion of the mass takes place because of a linear motor (not shown) whose individual elements (linear or exciter winding) are located circular or elliptical in imbalance exciter 12 in order to make a circular or elliptical motion possible. For this, for example, 256 elements can be used. The mass is suspended within imbalance exciter 12—electromagnetically controlled during operation of imbalance exciter 12, in particular, within the individual elements.

According to a second preferred variation, the imbalance of imbalance exciter 12 is based primarily on two corresponding units, i.e. units that are provided with the same form and consist of the same materials (masses are not shown). During operation of imbalance exciter 12, these masses revolve around mast 11 within imbalance exciter 12, i.e. the masses revolve in a circle (or elliptical) around mast axis 19, and do so radially outside of lateral surfaces or casing surfaces 20 of mast 11. Thereby the displacement levels of the two masses are axially offset with one another along mast axis 19; however, they primarily show an identical radial distance to the mast axis. In a parallel displacement of the masses this leads to, as in the case of only one mass, to a circling displacement of mast 11 around mast axis 19 in the static condition of mast 11. In a displacement of the masses in the opposite direction, however, a linear displacement of mast 11 results, i.e. the mast oscillates on one level parallel to mast axis 19 in static condition. Mast 11 can thus also be excited to perform linear displacements in particular oscillations as a result of the artificially generated force of this imbalance exciter 12

In a second variation as well, the motion of the mass takes place on account of linear motors (not shown), in this case, however, two linear motors, one for each mass. The linear motors are located in the imbalance exciter in such a way that that during operation they are positioned above one another on the mast (relative to the mast axis). The individual elements (linear or exciter windings) of each imbalance exciter are in turn located in a circle or elliptically in imbalance exciter 12, in order to make a circular or elliptical motion of the masses possible.

In both variations of the imbalance exciter a torsional force can be created to act upon the mast, by braking and/or accelerating the mass or masses in a suitable manner with the linear motors.

Further, several acceleration sensors, 13, 14 pertain to mechanism 10 for capturing acceleration measurements of mast 11. These are located distributed over the mast height of mast 11. Specifically, for this purpose, at least two horizontal acceleration sensors 13 are positioned along a line parallel to mast axis 19 in the lowest third, in the middle third and the upper third (close to mast top 15) of mast height h of mast 11. At one level perpendicular to mast axis 19, at the level of the uppermost horizontal acceleration sensor 13, two additional horizontal acceleration sensors 13 are located, respectively offset with one another at the lateral surface or casing surface by 90° (in FIG. 1 an acceleration sensor is hidden on the posterior side of the mast). The meaning of the description “horizontal acceleration sensors” is to be understood to mean that these acceleration sensors 13 are located on mast 11 in such a way that they capture an acceleration of mast 11 (primarily) in horizontal direction.

Further, three, preferably four vertical acceleration sensors 14 respectively offset by 90° are located at mast base 16 opposite to one another at the lateral surfaces or casing surfaces 20 of mast 11, which capture a (primarily) vertical displacement of mast 11, i.e. a displacement (primarily) parallel to mast axis 19.

Finally, an analysis arrangement 21, which is shown symbolically in FIG. 1, also pertains to mechanism 10. The analysis arrangement 21 can also be attached to the control or regulation of the entire mechanism 10, so that it is then a control and analysis unit 21. An analysis on location could also be forgone, so that it would merely be a capturing arrangement 21 for measurements or a control and capturing arrangement 21 in this case.

The individual components of the mechanism can be connected with one another by cable for transmitting control commands and/or measurements, but radio transmission is possible as well. The energy supply of the individual components can take place independently via batteries or accumulators or via cable connections that initiate from a central energy source.

With mechanism 10, the process according to the invention for testing the stability and/or bending strength of masts 11, in particular non-guyed masts 11 can be performed.

For this, mast 11 is excited to oscillate in the uppermost third of mast height h by the imbalance of imbalance exciter 12. The horizontal acceleration sensors 13 capture the acceleration measurements (acceleration signals) at their respective positions (measuring points) on mast 11 and transfer such for recording and/or analysis to capturing and/or analysis arrangement 21.

For example, with respect to the analysis, the deflection of the mast at various levels can be calculated by twofold integration of the acceleration signals, and thus a measured bending line of mast 11 can be determined. By comparing these measured bending lines, in particular a deflection line that has been calculated for the load applied (i.e. the force effect on mast 11 generated by imbalance exciter 12) and the specific cross section of mast 11 and the mast material, conclusions about the material characteristics of mast 11 can be drawn and material defects, inclusions and breaks can be recognized.

If the analysis of the determined values results in critical or doubtful results for a certain direction of deflection of mast 11, mechanism 10 makes an additional targeted and perhaps also more detailed analysis of this direction of deflection possible by a corresponding arrangement of acceleration sensor 13 (if necessary also 14).

The arrangement of four acceleration sensors 13 at one level in the uppermost third of mast height h also delivers information about the deflection of mast 11 by twofold integration that can differ not only in direction, but also in degree. This analysis makes it possible to draw conclusions concerning cross section deformations and distortions of the mast that can thus be documented and, particularly, by including material characteristics for evaluation.

The measurements of the arrangement of the four vertical acceleration sensors 14 at respectively two opposite sides of the mast base make the determination of toppling of foundation 17 possible by calculating the vectors (again by twofold integration) and by considering the distance of the vertical acceleration sensors 14. Thereby, the likelihood of a toppling of mast 11 can be assessed, i.e. the stability of mast 11.

Finally, varying the rotational speed of the imbalance (of the mass), the frequency response, the dampening coefficient as well as the maximum deflection of mast 11 and thus the internal frequency of mast 11 can be determined. This frequency represents the critical case for wind excitement. Therefore, the wind excitement may not excite the internal frequency of mast It. The (captured) internal frequency of mast 11 must therefore be outside of a critical frequency range. Otherwise, adaptation measures for changing the internal frequency may, as the case may be, be required.

The described testing process has the advantage that the course of the deflection line is proportional to the load in the elastic section of the material and therefore one can work with small imbalances for excitement and thus with small forces. Thus, there is no danger of overloading the mast so that the likelihood of damaging the mast during the test is small, in any event significantly smaller than in processes of prior art that were explained at the beginning, which require a mast load that is significantly more than the natural maximum wind load that is to be expected.

The described mechanism is particularly suited for round and/or oval masts with a diameter of maximally 50 cm, in particular of maximally 30 cm.

FIG. 2 shows a diagram of a further example of an embodiment of an imbalance exciter 12 in cross section with respect to the longitudinal mast axis, attached to a mast 11 that is to be tested. In this example of an embodiment the mass of the imbalance exciter 12 comprises a base mass 28 and a trim mass 29, whereby the important radial distance 8 can be set at a projection to a vertical level between base mass 28 and trim mass 29 with a distance setting component 30. In this manner it is guaranteed that a force that is adapted to the testing process can be selected by the user or can also be changed during the testing process.

In the embodiment form shown at hand, base mass 28 is in motion on a circular track 31. Simultaneously, it is possible to change the distance δ of trim mass 29 from base mass 28 coordinated with the revolving frequency base mass 28 in such a way, that in spite of the circular revolving track of base mass 28, an elliptically distributed force is created, i.e. the effect of a single revolving mass on an elliptical track is achieved.

FIG. 3 shows an example of an embodiment of a robot 22 of a mechanism 10 according to the invention, and that in a condition in which it is not affixed to mast 11, i.e. prior to or after an attachment to mast 11. FIG. 4 shows this robot 22 in a condition attached to mast 11. A comparison of FIG. 3 and FIG. 4 shows, that robot 22 consists of several components that are connected with one another for affixing to mast 11, and for removing robot 22 from mast 11 they are again detached from one another. For this, hinge connections can also be provided, so that the individual components of robot 22 are also connected with one another in removed condition.

Robot 22 includes a base support 23, which is formed ring-shaped in the condition in which it is attached to mast 11, and thus surrounds mast 11 in a ring-shape. Several wheels 24 are attached to base support 23 via mounting suspensions 25. The wheels 24 abut (in attached condition of robot 22) in a circle around the axis of the mast. The position of the wheels can be adjusted via their mounting suspensions, so that the radius of the circle arrangement of wheels 24 can be adjusted. Thus, robot 22 can be adapted to various diameters of the mast.

In the attached condition (FIG. 4) the position of wheels 24 are shown in such a way that wheels 24 abut on mast 11. The surface of wheels 24 shows high friction that holds the robot while driving along mast 11. Locking of the measuring position takes place by locking means, in particular locking spindles, preferably 3. The locking means effect a preferably un-dampened coupling into the locking forces.

The wheels can be rotated by a drive 26, so that robot 22 can be driven up and down on the mast and do so self-directed. An adaptation to a changing mast diameter can also be accommodated by mounting suspension 25.

Measurement arrangements can be attached to robot 22, for example acceleration sensors. These can then be driven to the desired measurement levels by robot 22. Attachment of an imbalance exciter to robot 22 is also possible.

Thus, overall, a process and a mechanism for testing the stability of masts, in particular non-guyed masts is suggested with which especially the following statistical values of a mast can be tested: foundation toppling, deformation of a mast over the height and torsion load, frequency response, resonance coefficient and resonance frequency.

### REFERENCE NUMBERS

10 Mechanism

11 Mast

12 Imbalance exciter

13 Horizontal acceleration sensors

14 Vertical acceleration sensors

15 Mast top

16 Mast base

17 Foundation

18 Ground

19 Mast (longitudinal) axis

20 Lateral surface or casing surface

21 Evaluation and/or control and/or capturing arrangement

22 Robot

23 Base frame

24 Wheels

25 Mounting suspension

26 Drive

27 Locking means

28 Base mass

29 Trim mass

30 Distance setting components

31 Circular track

h Mast height

δ Distance between base mass and trim mass

1. A process for testing the stability or bending strength of a mast (11),
a) in which the test is dynamic,
b) whereby the mast (11) is excited into displacement by an artificially generated force, and
c) whereby the displacements of the mast (11) are captured by one or more sensors located on the mast (11), which capture acceleration values at their respective positions on the mast (11),
characterized by, that
the force is generated by two or more circular or elliptical masses that revolve around the mast or a longitudinal mast axis (19).

2. The process according to claim 1 in which the mast displacements are excited by a force that changes its direction or intensity over time.

3. The process according to claim 1 in which the mast displacements are excited by a force that changes its direction or intensity periodically.

4. The process according to according to claim 3, in which an excitement frequency of the force can be set, particularly, continuous.

5. The process according to claim 1 in which the force that is exciting the mast displacements is a force impulse or the consequence of a force impulse.

6. The process according to claim 1 in which the force is primarily on one level perpendicular to a longitudinal axis (19) of mast (11), and wherein is, directed radially to the longitudinal axis (19) of the mast (11).

7. The process according to claim 1 in which the force surrounds the longitudinal axis (19) of the mast (11) circular or elliptical, and such force is one selected of a periodic or at constant force over time.

8. The process according to claim 1, in which the direction of the force is constant on a straight line perpendicular to the longitudinal mast axis (19) and the force vector changes over time.

9. The process according to claim 1 in which the force applied at the mast (11) is torsional, and at least with respect to one force component tangential at a lateral or casing surface (20) of the mast.

10. The process according to claim 1 in which the force acting upon the mast (11) is generated by a mechanism (12) that is attached to the mast (11), at a location that is selected from one of the upper third of the mast height (h), an exterior side, or an exterior lateral or casing surface (20) of the mast (11).

11. The process according to claim 10, in which the mechanism (12) is an imbalance exciter (12).

12. The process according to claim 10, in which at least one of or the masses is driven by one or more linear drives, that includes one or more linear motors.

13. The process according to claim 10, in which at least one of the masses is suspended by an electromagnetic control or is mechanically guided.

14. The process according to claim 1 in which the preferred measurement values are horizontal acceleration values that are captured primarily on one level perpendicular to the longitudinal mast axis (19), or vertical acceleration values that are captured primarily parallel to the longitudinal mast axis (19).

15. The process according to claim 14, in which the horizontal acceleration values are captured on one or more measuring levels distributed over a mast height (h), including at least three measuring levels, whereby a first measuring level is located in a lower third of the mast height (h), a second measuring level is located in a middle third of the mast height (h), and a third measuring level is in a upper third of the mast height (h).

16. The process according to claim 15, in which the acceleration values of the various measuring levels are captured parallel by an arrangement of a corresponding quantity of acceleration sensors (13, 14).

17. The process according to claim 15, in which the acceleration values of various measuring levels are captured sequentially, in particular by using a robot (22) with acceleration sensors that can be directed sequentially to the respective measuring levels on the mast (11).

18. The process according to claim 14, in which in at least one measuring level, including in the upper-most measuring level, one or more acceleration values are captured, whereby the measuring points are distributed evenly over the measuring level at the mast (11).

19. The process according to claim 18, in which the acceleration values of one measuring level are determined parallel by a corresponding number of acceleration sensors (13, 14).

20. The process according to claim 18, in which the acceleration values of one measuring level are sequentially determined, in particular by attaching a robot (22) with one or more acceleration sensors to the mast which rotate one or more acceleration sensors around the longitudinal mast axis for capturing various measuring positions within a measuring level.

21. The process according to claim 14 in which one or more vertical acceleration values, are determined at or in the proximity of a mast base (16).

22. The process according to claim 14 in which
a) the mast deflection is calculated by twofold integration of the horizontal acceleration values of the respective measuring levels from which a measured bending line of the mast (11) is determined,
b) the measured bending line is compared with a control bending line by considering an excitement force or a mast cross section or mast material of a theoretically determined bending line or a zero measurement, and
c) deviations from the measured and control bending line including a theoretically determined bending line or zero measurement are determined.

23. The process according to claim 22, by which quality defects of the mast (11), at least selected one of material defect, inclusions or breaks are recognized resulting from the deviations determined between the measured and calculated bending line.

24. The process according to claim 14 in which the mast deflection is calculated in the respective measuring levels by twofold integration of the determined horizontal acceleration values and from this a force-deflection diagram is created from the course of which quality deficiencies of mast (11), in particular material defects or inclusions and/or breaks can be recognized.

25. The process according to claim 18 in which
a) mast deflections are determined in various directions that have been determined at one measuring level by twofold integration of several horizontal acceleration values, and
b) from differences between these deflections, with respect to the degree of a maximum deflection, quality deficiencies of the mast (11), cross section deformations and/or deformations of the mast (11) can be recognized.

26. The process according to claim 21 in which
a) the displacement of the respective measuring points is determined by twofold integration of the determined vertical acceleration values, including two acceleration values captured at opposite mast sides, and
b) the toppling of the mast (11) in its anchoring is determined by these displacements and the distance of the measuring points from one another.

27. The process according to claim 4, in which the frequency response, the dampening coefficient or the resonance frequency of the mast (11) is determined by the displacement of the mast (11) as a result of a force at various excitement frequencies, including from the maximum deflection of the mast (11) at various excitement frequencies.

28. A mechanism (10) for testing the stability or bending strength of masts (11), including
a) an imbalance exciter (12), that can be affixed to a mast (11) for generating a force that acts upon the mast (11) that is to be tested with at least one mass,
b) one or more acceleration sensors (13, 14), that can be affixed to the mast (11) for capturing acceleration values, and
c) an analysis arrangement (21) for determining the stability or bending strength of the mast (11) that is to be tested or of quality deficiencies of the mast (11) that is to be tested,
characterized by, that the imbalance exciter is designed in such a way that the at least one mass can be displaced circular or elliptical around the longitudinal axis (19) of the mast.

29. The mechanism according to claim 28, in which the at least one mass is driven by a linear drive.

30. The mechanism according to claim 29, in which the at least one mass is driven by a linear motor.

31. The mechanism according to claim 28, in which the masses are suspended electromagnetically controlled during operation of imbalance exciter (12) or are mechanically guided.

32. The mechanism according to claim 28, including at least one robot (22) for positioning acceleration sensors (13, 14) and/or an imbalance exciter (1 2) at the mast (11) that is to be tested, whereby the robot includes two or more components that are connected with one another and are placed or can be placed in a ring-shaped around the mast (11) to be tested, and includes at least one arrangement for affixing acceleration sensors (13, 14) or the imbalance exciter (12).

33. The mechanism to according claim 32, whereby the robot (22) includes a mechanism for a driving robot (22) along the mast.

34. The mechanism according to claim 33, whereby the robot (22) includes wheels (24) that abut the mast (11) while it is driven.

35. The mechanism according to claim 32, whereby the robot (22) includes a mechanism for rotating the arrangement for affixing acceleration sensors (13, 14) or the imbalance exciter (12) around the longitudinal mast axis (19).
